(19) United States
(12) Patent Application Publication
(10) Pub. No.: US 2026/0145870 A1
(43) Pub. Date: May 28, 2026

(54) PLASTIC BOTTLE COMPRESSION AND RECYCLING DEVICE

(71) Applicant: KUNMING BOXIAO PACKAGING MATERIALS CO., LTD., Kunming, Yunnan (CN)

(72) Inventors: Jonathan Zhi Zhou Zhang, Kunming, Yunnan (CN); Enbo Zhang, Kunming, Yunnan (CN); Jialei Chen, Kunming, Yunnan (CN); Ning LI, Kunming, Yunnan (CN); Shaoyan Zhang, Kunming, Yunnan (CN); Peigui Wu, Kunming, Yunnan (CN); Cheng Zhang, Kunming, Yunnan (CN); Guiming Zhang, Kunming, Yunnan (CN); Binghong Liu, Kunming, Yunnan (CN); Yufeng Ren, Kunming, Yunnan (CN); Ling Ping, Kunming, Yunnan (CN); Yihua Zhang, Kunming, Yunnan (CN); Wenda Li, Kunming, Yunnan (CN); Yungui Li, Kunming, Yunnan (CN); Chunlai Liu, Kunming, Yunnan (CN); Tao Yuan, Kunming, Yunnan (CN); Yunli Wang, Kunming, Yunnan (CN); Shasha Pu, Kunming, Yunnan (CN); Donghui Huo, Kunming, Yunnan (CN); Lidan Zhao, Kunming, Yunnan (CN)

(21) Appl. No.: 19/479,753

(22) PCT Filed: Sep. 28, 2025
(86) PCT No.: PCT/CN2025/124985

§ 371 Date: Oct. 29, 2025

(30) Foreign Application Priority Data
Nov. 5, 2024 (CN) 202411563478.5

(51) Int. Cl. B65F 1/14

(52) U.S. Cl. CPC B65F 1/1405; B65F 2210/1527; B65F 2210/162; B65F 2210/168; B65F 2240/1126

(57) ABSTRACT

The embodiments of the present disclosure disclose a plastic bottle compression and recycling device. The plastic bottle compression and recycling device includes a housing, and a compression cavity, a binding part, a compression part, a feeding part, a conveying part, a discharging part and a controller that are located inside the housing.

### CROSS-REFERENCE TO RELATED APPLICATION

The present disclosure claims the priority to the Chinese patent application with the filing No. 202411563478.5 filed with the Chinese Patent Office on Nov. 5, 2024, and entitled “PLASTIC BOTTLE COMPRESSION AND RECYCLING DEVICE”, the contents of which are incorporated herein by reference in entirety.

### TECHNICAL FIELD

The present disclosure relates to the technical field of plastic bottle recycling, and in particular, to a plastic bottle compression and recycling device.

### BACKGROUND ART

A plastic bottle recycling machine is a device specifically designed for recycling plastic bottles, which uses automated technology to help reduce an impact of plastic waste on the environment. Currently, common methods for recycling plastic bottles mainly include manual sorting and simple mechanical recycling. Manual sorting is inefficient, costly, and it is difficult to ensure sorting accuracy. Although mechanical recycling devices can improve recycling efficiency, most of these devices lack intelligent identification functions and cannot effectively sort plastic bottles of different materials, resulting in low purity of recycled materials, which affects subsequent recycling and reuse. During recycling, large-sized plastic bottles tend to occupy space, making subsequent packaging and transportation inconvenient. In addition, existing devices still have problems during operation, such as high reliance on manual labor, low compression efficiency, loud compressor noise, insufficient safety, and inability to be directly deployed in the end market for consumer use.

### SUMMARY

The technical problem to be solved by the present disclosure is to provide a plastic bottle compression and recycling device.

To solve the above technical problem, the technical solution of the present disclosure is as follows.

A plastic bottle compression and recycling device comprises a housing, and a compression cavity, a binding part, a compression part, a feeding part, a conveying part, a discharging part and a controller that are located inside the housing.

The compression cavity is fixedly connected to a frame at a lower portion of the housing.

A lower end of the binding part is further fixedly connected to an inner side of the frame. A machine frame at an upper end of the binding part is nested on the compression cavity. A lower end of the compression part is detachably connected to an upper end of the compression cavity.

The housing is provided with a feeding port and a discharging port. One end of the feeding part is fixedly connected to the housing at a lower end of the feeding port, and the other end of the feeding part is detachably connected to an opening in an upper half of the compression cavity.

The upper end of the compression cavity is detachably connected to the conveying part, and the conveying part is configured for conveying materials. The conveying part is arranged in a same direction as the feeding part, and is able to extend into an upper space of the compression cavity.

The controller is electrically connected to the compression cavity, the binding part, the compression part, and the conveying part respectively.

Optionally, a material identification module is detachably connected to the housing above the feeding part. The material identification module is electrically connected to the controller. A photoelectric sensor is detachably connected to an upper portion of the compression cavity.

Optionally, the compression cavity comprises a cavity shell, a pushing assembly, a cavity door, a first electric push rod, and a magnetic suction plate. The cavity shell is vertically provided with a through slot configured to be adapted to the binding part. The pushing assembly is arranged on a rear end of the cavity shell, and the cavity door is rotatably connected to a front end of the cavity shell. A tail end of the first electric push rod is detachably connected to one side where the cavity door is rotatably connected to the cavity shell, and an output end of the first electric push rod is detachably connected to an end face of the cavity door. The magnetic suction plate is arranged away from the cavity door, and is configured to fix the cavity shell to the cavity door. The pushing assembly comprises a second electric push rod, a push plate, sleeves, and guide rods. An output end of the second electric push rod is detachably connected to the push plate. An upper end and a lower end of the push plate are respectively fixedly connected to the guide rods. A sleeve is slidably sleeved on a guide rod. The sleeve is fixedly connected to the cavity shell.

Optionally, the conveying part comprises a connecting frame, a fixed guide rail, a sliding guide rail, a first motor, a driven wheel, and a rack. The connecting frame is fixedly connected to a first support member at the upper end of the compression cavity. The fixed guide rail is detachably connected below the first support member. The sliding guide rail is slidably connected to the fixed guide rail. A clamp is fixedly connected to a lower portion of the sliding guide rail. The first motor is detachably connected to an upper portion of the connecting frame. The driven wheel is fixedly connected to an output end of the first motor. The rack is fixedly connected to a side of the sliding guide rail through an L-shaped plate. The driven wheel is movable relative to the rack.

Optionally, the conveying part further comprises a rectangular bump and an arc-shaped bump. The rectangular bump is detachably connected to a lower end of a U-shaped support bracket. The arc-shaped bump is detachably connected to the lower end of the compression part. A front end of the first support member is detachably connected to the U-shaped support bracket. The clamp comprises a limiting member, clamping plates, horizontal connecting members, and springs. When the clamp moves toward one side of the feeding part, the limiting member contacts an inner side of the rectangular bump; when the clamp moves away from one side of the feeding part, the limiting member contacts an outer side of the rectangular bump. The two horizontal connecting members are detachably connected between the two clamping plates. A spring is detachably connected between a clamping plate and a horizontal connecting member. The limiting member is arranged above a clamping plate on one side where the rectangular bump is located, and is configured to realize opening and closing of the clamp. When the clamp moves toward the upper portion of the compression cavity, the limiting member contacts an arc surface of the arc-shaped bump, and is configured to realize the opening and closing of the clamp.

Optionally, an arc-shaped groove is provided on a lower portion of the clamping plate. The arc-shaped groove is arranged to be serrated, or provided with a rubber sheet by attaching. The feeding part is an arc-shaped plate that is matched with a shape of the conveying part. The discharging part is an obliquely arranged U-shaped spliced plate.

Optionally, the binding part adopts a binding machine or a packing machine.

Optionally, the compression part comprises a second motor, a belt, a drive shaft, a first screw rod, a second screw rod, a first pressing plate, and a second pressing plate. An output end of the second motor drives the first screw rod to perform a lifting movement through a worm gear. An end portion of the output end of the second motor is in transmission connection with the drive shaft via the belt. The drive shaft drives the second screw rod to perform a lifting movement through a worm gear. The first pressing plate is fixedly connected to a lower end of the first screw rod. The second pressing plate is fixedly connected to a lower end of the second screw rod. The first pressing plate and the second pressing plate are located on a same horizontal plane, and a gap adapted to the machine frame at the upper end of the binding part is reserved between the first pressing plate and the second pressing plate. A pressure sensor is provided below the first pressing plate and the second pressing plate.

Optionally, a collection port is provided at a position of the housing close to the feeding port. A collection trough is fixedly connected to an inside of the housing below the collection port. A display is provided on the housing, and the display is electrically connected to the controller.

Optionally, a turntable is rotatably connected to a U-shaped support bracket above the conveying part, and is configured for placing binding straps. A number of pulleys that facilitate a movement of the binding straps are fixedly connected to an outer wall of the compression cavity.

Beneficial effects of the present disclosure are as follows.
(1) By arranging the compression cavity, a space is provided for compressing and binding plastic bottles. The binding part is able to pack and bind the compressed plastic bottles. The compression part is able to effectively compress the plastic bottles. The conveying part is able to convey the plastic bottles fed into the feeding part, facilitating the stable falling of the plastic bottles into the compression cavity. The discharging part is able to discharge the compressed and bound plastic bottles. The controller is able to effectively control various parts of the plastic bottle compression and recycling device.
(2) Through the cooperation of the compression cavity, the binding part, the compression part, the feeding part, the conveying part, the discharging part, and the controller, the plastic bottles are effectively recycled, and a fully automated process is adopted, which reduces labor costs, improves the efficiency of binding and recycling, thereby ensuring the space utilization rate for packaging and transportation after recycling, and enhancing the safety of compression and recycling.

### BRIEF DESCRIPTION OF DRAWINGS

FIG. 1 is a schematic diagram showing an overall structure of a plastic bottle compression and recycling device provided in embodiments of the present disclosure;

FIG. 2 is a schematic structural diagram of a plastic bottle compression and recycling device with a housing wall removed provided in embodiments of the present disclosure;

FIG. 3 is a side view of FIG. 2;

FIG. 4 is a schematic structural diagram of a compression cavity;

FIG. 5 is a schematic structural diagram of a pushing assembly;

FIG. 6 is a schematic diagram showing an installation position of a conveying part;

FIG. 7 is a front view of FIG. 6;

FIG. 8 is a schematic structural diagram of a compression part;

FIG. 9 is a schematic diagram showing an installation position of a conveying part from another perspective;

FIG. 10 is an enlarged view of part A in FIG. 9;

FIG. 11 is a schematic structural diagram of a rectangular bump; and

FIG. 12 is a schematic structural diagram of an arc-shaped bump.

### IN THE FIGURES

1—housing, 2—compression cavity, 3—binding part, 4—compression part, 5—feeding part, 6—conveying part, 7—discharging part, 8—controller, 9—collection port, 10—display;
11—frame, 12—feeding port, 13—discharging port;
21—cavity shell, 22—pushing assembly, 23—cavity door, 24—first electric push rod, 25—magnetic suction plate, 26—first support member, 27—U-shaped support bracket;
221—first electric push rod, 222—push plate, 223—sleeve, 224—guide rod;
31—machine frame, 32—turntable, 33—pulley;
41—second motor, 42—belt, 43—drive shaft, 44—first screw rod, 45—second screw rod, 46—first pressing plate, 47—second pressing plate;
61—connecting frame, 62—fixed guide rail, 63—sliding guide rail, 64—first motor, 65—driven wheel, 66—rack, 67—clamp; 68—rectangular bump; 69—arc-shaped bump;
671—limiting member, 672—clamping plate, 673—horizontal connecting member, 674—spring, 675—arc-shaped groove;
91—collection trough.

### DETAILED DESCRIPTION OF EMBODIMENTS

The specific embodiments of the present disclosure will be further described below with reference to the drawings. It should be noted here that the descriptions of these embodiments are used to help understand the present disclosure, but do not constitute limitations on the present disclosure. In addition, the technical features involved in the various embodiments of the present disclosure described below can be combined with each other as long as they do not conflict with one another.

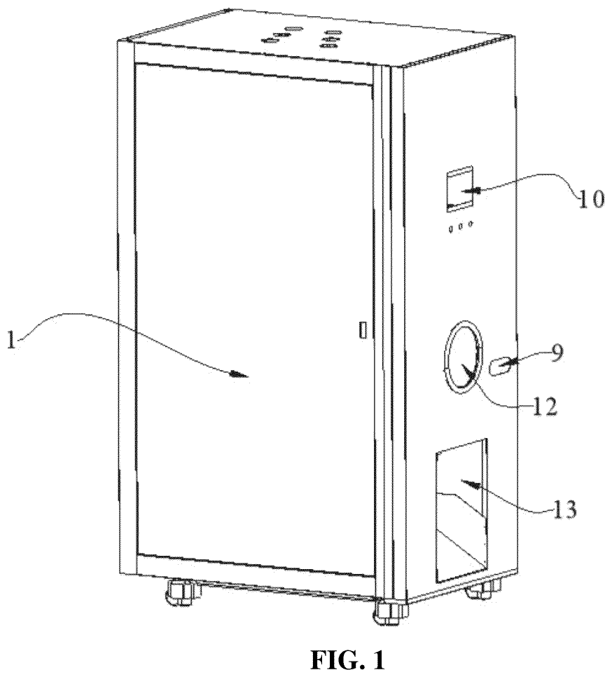

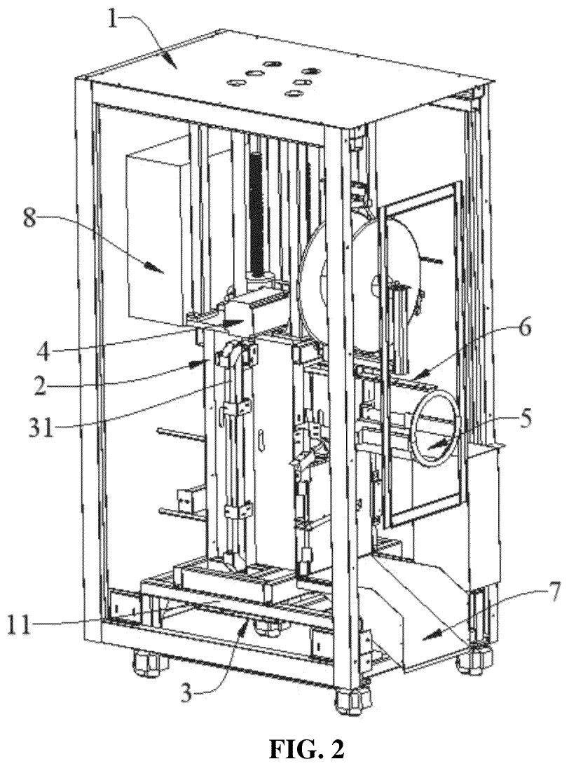

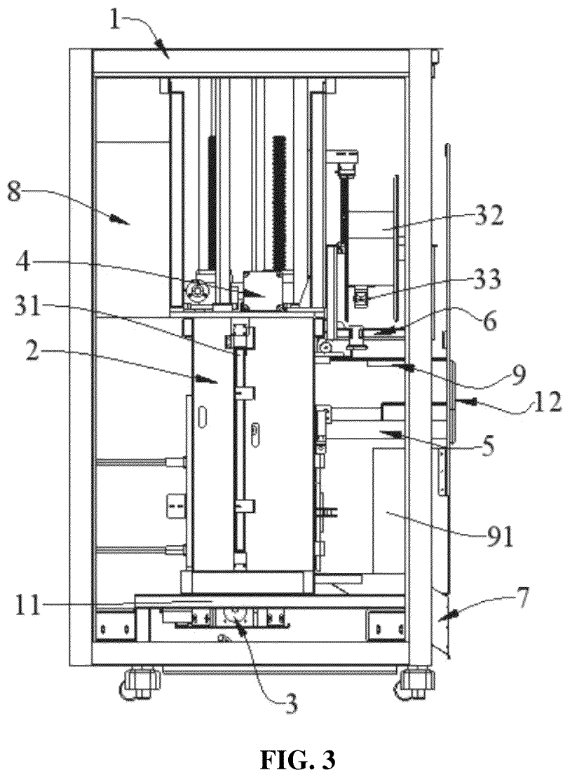

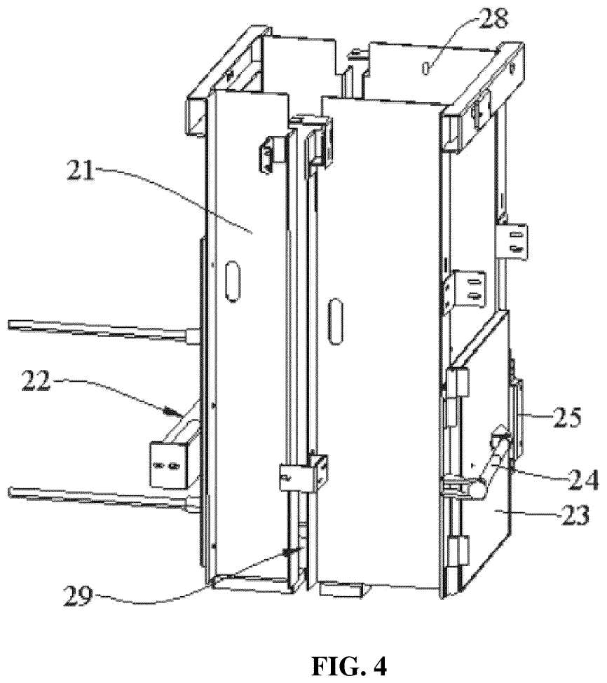

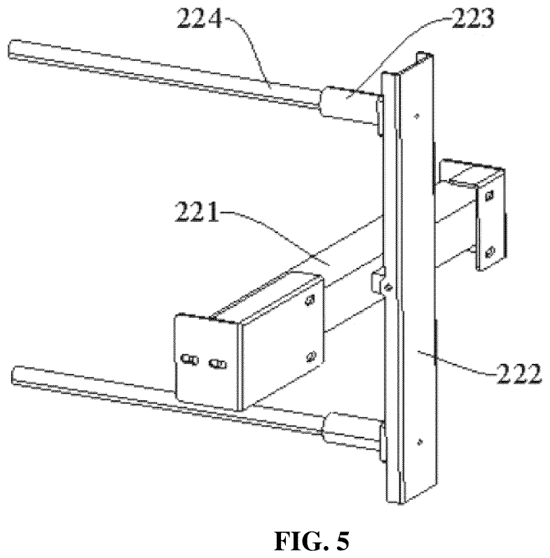

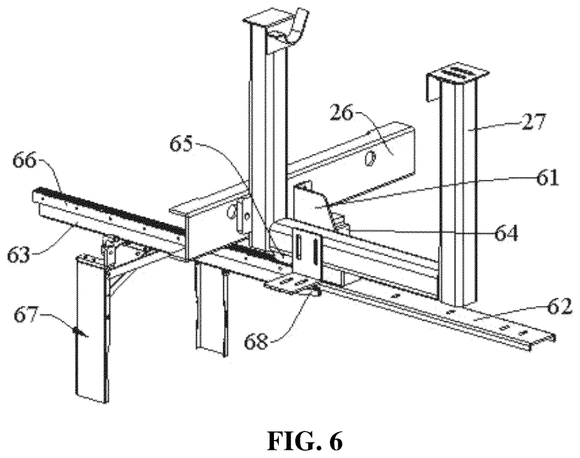

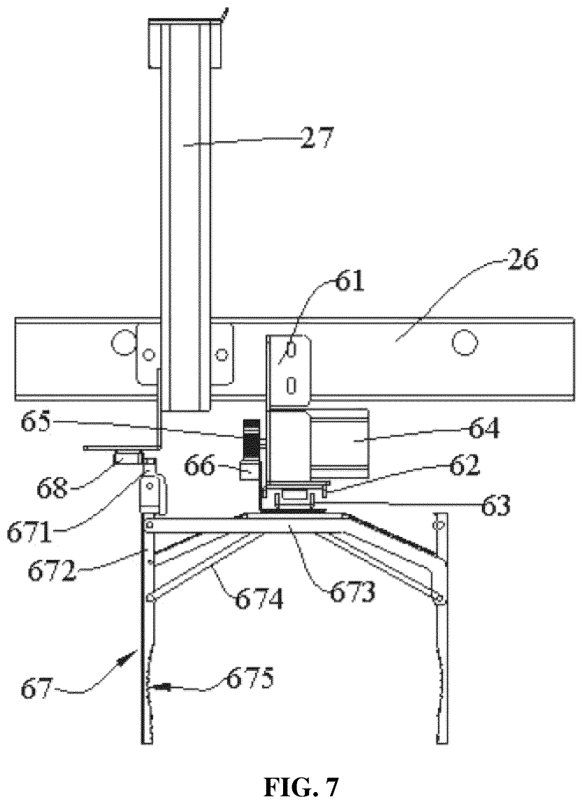

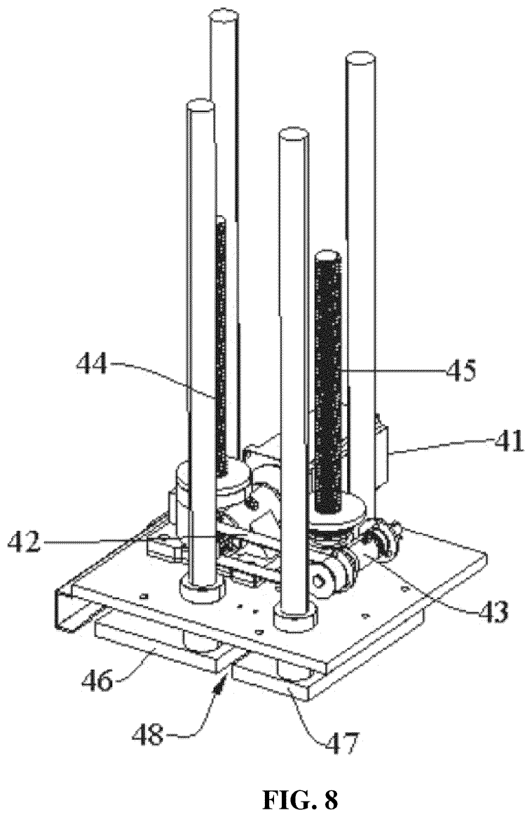

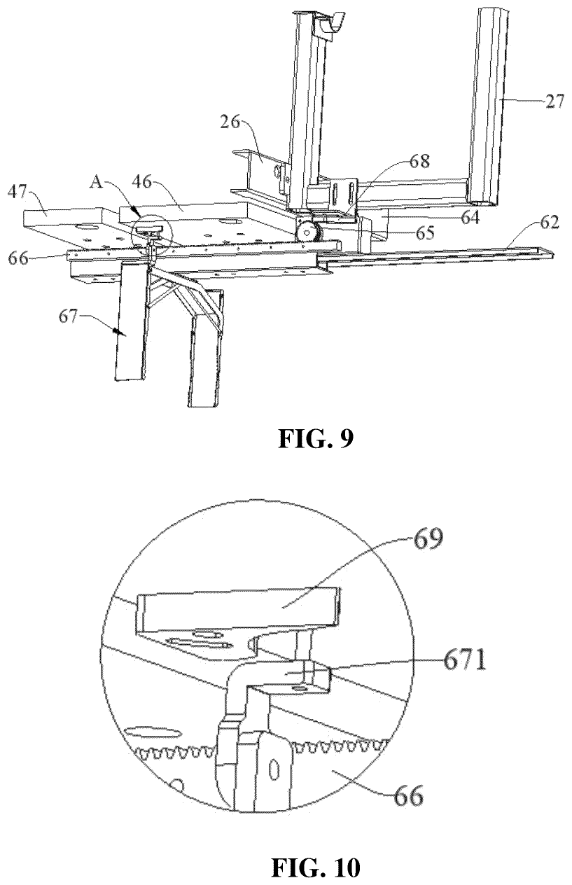

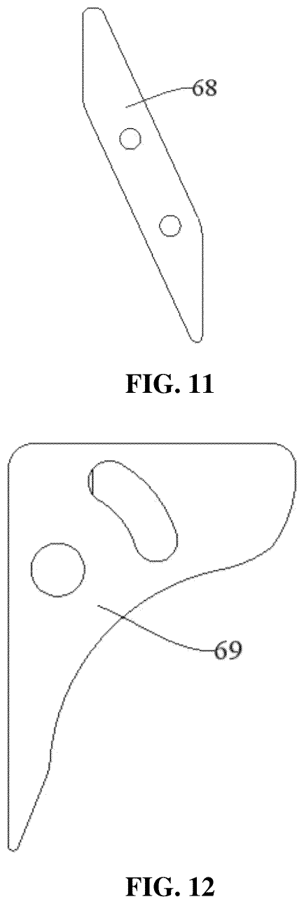

Referring to FIGS. 1-12, a plastic bottle compression and recycling device provided in embodiments of the present disclosure includes a housing 1, and a compression cavity 2, binding part(s) 3, a compression part 4, a feeding part 5, a conveying part 6, a discharging part 7 and a controller 8 that are located inside the housing 1.

It should be noted that the housing 1 is a containing component of the plastic bottle compression and recycling device. The compression cavity 2 serves as a space for compressing plastic bottles, where compression and binding can be performed. The binding part 3 is able to pack and bind the compressed plastic bottles. The compression part 4 is able to effectively compress the plastic bottles. The conveying part 6 is able to convey the plastic bottles fed into the feeding part 5, facilitating the stable falling of the plastic bottles into the compression cavity 2. The discharging part 7 is able to discharge the compressed and bound plastic bottles. The controller 8 is able to effectively control various parts of the plastic bottle compression and recycling device.

For the convenience of compression and packing, the compression cavity 2 is fixedly connected to a frame 11 at a lower portion of the housing 1.

A lower end of the binding part 3 is further fixedly connected to an inner side of the frame 11. A machine frame 31 at an upper end of the binding part 3 is nested on the compression cavity 2. A lower end of the compression part 4 is detachably connected to an upper end of the compression cavity 2. The binding part 3 is located at a vertical position of the compression cavity 2, and is able to effectively bind the compressed plastic bottles in the compression cavity 2. A plurality of binding parts 3 can be provided to bind the plastic bottles, thereby ensuring the stability of the binding.

For the convenience of feeding and discharging, the housing 1 is provided with a feeding port 12 and a discharging port 13. One end of the feeding part 5 is fixedly connected to the housing 1 at a lower end of the feeding port 12, and the other end of the feeding part 5 is detachably connected to an opening in an upper half of the compression cavity 2.

The upper end of the compression cavity 2 is detachably connected to the conveying part 6, which is configured for conveying materials. The conveying part 6 is arranged in the same direction as the feeding part 5, and can extend into an upper space of the compression cavity 2. The conveying part 6 is able to effectively transport the bottles into the compression cavity 2.

The controller 8 is electrically connected to the compression cavity 2, the binding part(s) 3, the compression part 4, and the conveying part 6 respectively. Through the control of the controller 8, orderly movements of various parts are able to be effectively ensured, thereby ensuring the normal operation of the device. The controller 8 is a commercially available product, and those skilled in the art can select the controller 8 according to actual needs for adaptation. A conventional PLC controller can meet the requirements.

Optionally, a material identification module is detachably connected to the housing 1 above the feeding part 5. The material identification module is electrically connected to the controller 8. A photoelectric sensor 28 is detachably connected to an upper portion of the compression cavity 2. The material identification module uses a Raman spectrometer for material detection, and a detection result is fed back to the controller 8. The photoelectric sensor 28 is able to detect a height of the plastic bottles inside the compression cavity 2. When the height reaches a preset position, the controller 8 controls the compression part 4 to move and compress the plastic bottles.

Optionally, the compression cavity 2 includes a cavity shell 21, a pushing assembly 22, a cavity door 23, a first electric push rod 24, and a magnetic suction plate 25. The cavity shell 21 is vertically provided with a through slot 29, which is configured to be adapted to the binding part 3. The pushing assembly 22 is arranged on a rear end of the cavity shell 21, and the cavity door 23 is rotatably connected to a front end of the cavity shell 21. A tail end of the first electric push rod 24 is detachably connected to one side where the cavity door 23 is rotatably connected to the cavity shell 21, and an output end of the first electric push rod 24 is detachably connected to an end face of the cavity door 23. The magnetic suction plate 25 is arranged away from the cavity door 23, and is configured to fix the cavity shell 21 to the cavity door 23. The pushing assembly 22 includes a second electric push rod 221, a push plate 222, sleeves 223, and guide rods 224. An output end of the second electric push rod 221 is detachably connected to the push plate 222. An upper end and a lower end of the push plate 222 are respectively fixedly connected to the guide rods 224. The sleeve 223 is slidably sleeved on the guide rod 224. The sleeve 223 is fixedly connected to the cavity shell 21.

The cavity shell 21 is able to ensure the stability of plastic bottle compression. The pushing assembly 22 is able to push out the plastic bottles after the compression and binding are completed. The cavity door 23 is closed during compression to ensure the stability of compression. When the plastic bottles need to be taken out, the controller 8 controls the first electric push rod 24 to contract to open the cavity door 23, at which time the pushing assembly 22 moves to push out the plastic bottles. The magnetic suction plate 25 is able to further ensure the stability of compressing the plastic bottles. The through slot 29 is provided to ensure the installation of the binding part 3, so that a binding strap is not interfered with by other components during binding.

The second electric push rod 221 provides power support for pushing out the plastic bottles. The push plate 222 is a vertical plate, which can effectively ensure a contact with the plastic bottles to a great extent, so as to push the plastic bottles out effectively. The cooperation between the sleeve 223 and the guide rod 224 is able to prevent the second electric push rod 221 and the push plate 222 from skewing during movement.

Optionally, the conveying part 6 includes a connecting frame 61, a fixed guide rail 62, a sliding guide rail 63, a first motor 64, a driven wheel 65, and a rack 66. The connecting frame 61 is fixedly connected to a first support member 26 at the upper end of the compression cavity 2. The fixed guide rail 62 is detachably connected below the first support member 26. The sliding guide rail 63 is slidably connected to the fixed guide rail 62. A clamp 67 is fixedly connected to a lower portion of the sliding guide rail 63. The first motor 64 is detachably connected to an upper portion of the connecting frame 61. The driven wheel 65 is fixedly connected to an output end of the first motor 64. The rack 66 is fixedly connected to a side of the sliding guide rail 63 through an L-shaped plate. The driven wheel 65 is movable relative to the rack 66.

The connecting frame 61 is able to facilitate the stable connection between the conveying part 6 and other components. The fixed guide rail 62 can be fixed to the connecting frame 61. The sliding guide rail 63 can move relative to the fixed guide rail 62, thereby driving the clamp 67 to move and grab the plastic bottles into the compression cavity 2. The first motor 64 can drive the driven wheel 65 to move the rack 66. The rack 66 is fixedly connected to the side of the sliding guide rail 63 through the L-shaped plate, so that the sliding guide rail 63 can be driven to move by the first motor 64.

Optionally, the conveying part 6 provided in the embodiments of the present disclosure further includes a rectangular bump 68 and an arc-shaped bump 69. The rectangular bump 68 is detachably connected to a lower end of a U-shaped support bracket 27. The arc-shaped bump 69 is detachably connected to the lower end of the compression part 4. A front end of the first support member 26 is detachably connected to the U-shaped support bracket 27. The clamp 67 includes a limiting member 671, clamping plates 672, horizontal connecting members 673, and springs 674. When the clamp 67 moves toward one side of the feeding part 5, the limiting member 671 contacts an inner side of the rectangular bump 68; and when the clamp 67 moves away from one side of the feeding part 5, the limiting member 671 contacts an outer side of the rectangular bump 68. The two horizontal connecting members 673 are detachably connected between the two clamping plates 672. The springs 674 are detachably connected between the clamping plates 672 and the horizontal connecting members 673. The limiting member 671 is arranged above the clamping plate 672 on one side where the rectangular bump 68 is located, and is configured to realize the opening and closing of the clamp. When the clamp 67 moves toward the upper portion of the compression cavity 2, the limiting member 671 contacts an arc surface of the arc-shaped bump 69, and is configured to realize the opening and closing of the clamp 67.

Short sides of the rectangular bump 68 are parallel to a moving direction of the sliding guide rail 63. When the limiting member 671 passes by the rectangular bump 68, the limiting member 671 contacts the inner side of the rectangular bump 68 when the clamp 67 moves toward one side of the feeding part 5, causing the springs 674 to stretch, and at this time, the clamp 67 switches from a clamping state to an open state. When the limiting member 671 is separated from the rectangular bump 68, the springs 674 contract, enabling the clamping plates 672 to just clamp the plastic bottle(s). Then, the controller 8 reverses its operation to drive the rack 66 to move away from the feeding part 5. At this time, the limiting member 671 contacts the outer side of the rectangular bump 68. At this time, the limiting member 671 is in an active state without exerting a force on the clamp 67, so that the clamp 67 still maintains the clamping state. After the clamp 67 moves to a position above the compression cavity 2, the limiting member 671 just contacts the arc surface of the arc-shaped bump 69, and the springs 674 stretch to make the clamp 67 switch to the open state. The plastic bottle(s) fall into the compression cavity 2, and the clamp 67 completes a clamping process.

Optionally, an arc-shaped groove 675 is provided on a lower portion of the clamping plate 672. The arc-shaped grooves 675 are able to effectively clamp plastic bottles of different specifications. The arc-shaped groove 675 is arranged to be serrated, or provided with a rubber sheet by attaching. The serrated arrangement or rubber sheet attachment can make clamping of plastic bottle(s) more stable. The feeding part 5 is an arc-shaped plate that is matched with the shape of the conveying part 6. The discharging part 7 is an obliquely arranged U-shaped spliced plate. The arrangement of the arc-shaped plate and the U-shaped spliced plate is to facilitate feeding and discharging.

Optionally, the binding part 3 adopts a binding machine or a packing machine. The binding machine or the packing machine is prior art, and those skilled in the art can select a suitable binding machine or packing machine according to needs and embed it in the compression cavity 2 for use.

Optionally, the compression part 4 provided in the embodiments of the present disclosure includes a second motor 41, a belt 42, a drive shaft 43, a first screw rod 44, a second screw rod 45, a first pressing plate 46, and a second pressing plate 47. An output end of the second motor 41 drives the first screw rod 44 to perform a lifting movement through a worm gear. An end portion of the output end of the second motor 41 is in transmission connection with the drive shaft 43 via the belt 42. The drive shaft 43 drives the second screw rod 45 to perform a lifting movement through a worm gear. The first pressing plate 46 is fixedly connected to a lower end of the first screw rod 44. The second pressing plate 47 is fixedly connected to a lower end of the second screw rod 45. The first pressing plate 46 and the second pressing plate 47 are located on the same horizontal plane, and a gap 48 adapted to the machine frame 31 at the upper end of the binding part 3 is reserved between the first pressing plate 46 and the second pressing plate 47. Pressure sensor(s) are provided below the first pressing plate 46 and the second pressing plate 47.

The second motor 41 drives the first screw rod 44 and the second screw rod 45 to perform the lifting movement respectively through the worm gear transmission and the belt transmission, thereby compressing the plastic bottles that need to be compressed and are placed in the compression cavity 2, so as to ensure that there is still space inside the compression cavity 2 for placing and compressing bottles subsequently entering. The pressure sensor can detect a pressure and transmit it to the controller 8 in real time.

Optionally, a collection port 9 is provided at a position of the housing 1 close to the feeding port 12. A collection trough 91 is fixedly connected to the inside of the housing 1 below the collection port 9. A display 10 is provided on the housing 1, and the display 10 is electrically connected to the controller 8.

The collection port 9 and the collection trough 91 cooperate to collect debris such as bottle caps in an early stage of plastic bottle recycling. The display 10 is a commercially available product, and those skilled in the art can select it according to actual needs. The display 10 can display the number of plastic bottles, and can also be designed into an interactive scene to increase interestingness and improve enthusiasm of users for putting plastic bottles into the device.

Optionally, a turntable 32 is rotatably connected to the U-shaped support bracket 27 above the conveying part 6, and is configured for placing binding straps. The turntable 32 facilitates the placement of binding straps. A number of pulleys 33 that facilitate the movement of binding straps are fixedly connected to an outer wall of the compression cavity 2.

The working principle of the embodiments of the present disclosure is as follows.

First, plastic bottles to be recycled are fed from the feeding port 12. The plastic bottles reach the feeding part 5, and their material is identified by the material identification module disposed above the feeding part 5. If the material is that of a recyclable plastic bottle, the controller 8 controls the conveying part 6 to clamp the plastic bottles placed on the feeding part 5. After clamping, the conveying part 6 moves to the position above the compression cavity 2 and then opens, thereby allowing the plastic bottles to fall steadily into the compression cavity 2. At this point, a plastic bottle feeding process is completed.

Through the detection of the controller 8, when the photoelectric sensor 28 senses that the bottles placed in the compression cavity 2 reaches a set height, or the material identification module identifies that the number of plastic bottles reaches a preset quantity, the controller 8 controls the clamp of the conveying part 6 to move to the position above the feeding part 5, and then the compression part 4 is started to compress the stacked plastic bottles in the compression cavity 2, thereby reducing the space occupied by the stacked plastic bottles to ensure the feeding of subsequent plastic bottles. When the number of fed plastic bottles reaches a set quantity, the controller 8 controls the compression part 4 to compress the stacked plastic bottles and simultaneously controls the binding part(s) 3 to bind and pack the stacked plastic bottles. After the packing is completed, the compression part 4 rises and returns to its original position. The first electric push rod 24 contracts to drive the cavity door 23 to open, and then the second electric push rod 221 drives the push plate 222 to extend, so as to push out the bound and packed plastic bottles. The bound plastic bottles slide out of the device through the discharging part 7, and the worker performs the recycling process for them.

The embodiments of the present disclosure are described in detail above with reference to the drawings, but the present disclosure is not limited to the described embodiments. For those skilled in the art, without departing from the principle and spirit of the present disclosure, various changes, modifications, substitutions, and variations made to these embodiments still fall within the protection scope of the present disclosure.

### INDUSTRIAL APPLICABILITY

In conclusion, the embodiments of the present disclosure provide the plastic bottle compression and recycling device, which enables effective recycling of plastic bottles, and reduces labor costs and improves the efficiency of binding and recycling by adopting the fully automated process, thereby ensuring the space utilization rate for packaging and transportation after recycling, and enhancing the safety of compression and recycling.

1. A plastic bottle compression and recycling device, comprising a housing, and a compression cavity, a binding part, a compression part a feeding part, a conveying part a discharging part and a controller that are located inside the housing, wherein
the compression cavity is fixedly connected to a frame at a lower portion of the housing;
a lower end of the binding part is further fixedly connected to an inner side of the frame; a machine frame at an upper end of the binding part is nested on the compression cavity; and a lower end of the compression part is detachably connected to an upper end of the compression cavity;
the housing is provided with a feeding port and a discharging port; one end of the feeding part is fixedly connected to the housing at a lower end of the feeding port, and the other end of the feeding part is detachably connected to an opening in an upper half of the compression cavity;
the upper end of the compression cavity is detachably connected to the conveying part, and the conveying part is configured for conveying materials; and the conveying part is arranged in a same direction as the feeding part and is able to extend into an upper space of the compression cavity;
the controller is electrically connected to the compression cavity, the binding part, the compression part, and the conveying part respectively;
a material identification module is detachably connected to the housing above the feeding part; the material identification module is electrically connected to the controller; and a photoelectric sensor is detachably connected to an upper portion of the compression cavity;
the compression cavity comprises a cavity shell a pushing assembly, a cavity door, a first electric push rod, and a magnetic suction plate, wherein the cavity shell is vertically provided with a through slot configured to be adapted to the binding part; the pushing assembly is arranged on a rear end of the cavity shell, and the cavity door is rotatably connected to a front end of the cavity shell; a tail end of the first electric push rod is detachably connected to one side where the cavity door is rotatably connected to the cavity shell, and an output end of the first electric push rod is detachably connected to an end face of the cavity door; the magnetic suction plate is arranged away from the cavity door, and is configured to fix the cavity shell to the cavity door; the pushing assembly comprises a second electric push rod a push plate sleeves, and guide rods; an output end of the second electric push rod is detachably connected to the push plate; an upper end and a lower end of the push plate are respectively fixedly connected to the guide rods; a sleeve is slidably sleeved on a guide rod; and the sleeve is fixedly connected to the cavity shell; and
the conveying part comprises a connecting frame a fixed guide rail, a sliding guide rail, a first motor, a driven wheel, and a rack, wherein the connecting frame is fixedly connected to a first support member at the upper end of the compression cavity; the fixed guide rail is detachably connected below the first support member; the sliding guide rail is slidably connected to the fixed guide rail; a clamp is fixedly connected to a lower portion of the sliding guide rail; the first motor is detachably connected to an upper portion of the connecting frame the driven wheel is fixedly connected to an output end of the first motor; the rack is fixedly connected to a side of the sliding guide rail through an L-shaped plate; and the driven wheel is movable relative to the rack.

2. The plastic bottle compression and recycling device according to claim 1, wherein the conveying part further comprises a rectangular bump and an arc-shaped bump, wherein the rectangular bump is detachably connected to a lower end of a U-shaped support bracket; the arc-shaped bump is detachably connected to the lower end of the compression part; a front end
